(19) United States
(12) Patent Application Publication
(10) Pub. No.: US 2013/0140245 A1
(43) Pub. Date: Jun. 6, 2013

(54) DIRECT CONTACT CELL

(71) Applicant: Neohydro Corp., Sugar Land, TX (US)

(72) Inventor: Constantinos Dean Themy, Missouri City, TX (US)

(73) Assignee: Neohydro Corp., Sugar Land, TX (US)

(21) Appl. No.: 13/688,275

(22) Filed: Nov. 29, 2012

Related U.S. Application Data
(60) Provisional application No. 61/565,646, filed on Dec. 1, 2011.

(51) Int. Cl. C02F 1/467

(52) U.S. Cl. CPC C02F 1/4672
USPC 210/748.17; 210/192

(57) ABSTRACT

A direct contact cell is useful for the purification of water and sterilization of organics and inorganics used in water purification systems, such as waste water reuse. Specifically, this direct contact cell is useful for the treatment of flow back and produced waters in the oil and gas industry and also the mining industry, for the destruction of pathogens, heavy metals, suspended solids, iron, cyanide fats and organic material. The direct contact electrolytic cell allows a single passage through the cell to handle flow rates of up to 42 gallons per minute. The cell provides a plurality of separate anodes disposed with the cell and cathodes in front of and behind the anodes and can be operated at high voltages.

### BACKGROUND

This application claims priority to U.S. Provisional Patent Application Ser. No. 61/565,646, entitled DIRECT CONTACT CELL, filed on Dec. 1, 2011, the entire content of which is hereby incorporated by reference.

This disclosure relates to an electro oxidation system in the form of a direct contact cell for the purification of water and sterilization of organics and inorganics used in water purification systems, such as waste water reuse.

Electrolytic generation of chlorine from brine solutions is conducted using an applied anode voltage of about 3.5 to 7 volts. Using proprietary anodes produced using trade secret manufacturing methods that combine precious metals of pure platinum, iridium, rhodium and titanium, with all metals layered, mixed oxidants are concurrently produced including hydroxyl radicals, ozone, chlorine, hydrogen peroxide and hypochlorus acid. As the voltage increases, the rate of oxidants become more apparent and more powerful as destruction of organics and inorganic occurs. Above about 18 V DC and particularly above about 240 amps DC, a change in the electrolysis of brine solutions takes place, resulting in the generation of free radicals, hydroxyl radicals, ozone, chlorine, hypochlorite hypochlorus acid and hydrogen peroxide. Other anodes have an operational limit of 10-12 volts due to damage that occurs to the electrodes at higher operating voltages. Although some electrodes may operate at high voltages (i.e. >12 volts) for short periods of time, pitting and catastrophic damage resulting in failure of the electrode soon occurs. Further, some electrodes are sacrificial, meaning that their repeated replacement is customary and expected, and have to be replaced even at low voltages.

Various sacrificial electrodes and methods for producing sacrificial electrodes are known in the art. However, for large scale and continuous operation of a high current electro-oxidation system that produces hydroxyl radicals, ozone, chlorine. hypochlorus acid and hydrogen peroxide for the treatment of organics and inorganics needed for wastewater purification as described herein, the ability to run for much longer periods of time at even higher voltages is needed. Continuous high current electro oxidation may be desired in a variety of water purification/sterilization systems including treatment of frac water for the destruction of bacteria, suspended solids, heavy metals, iron, barium, and strontium. Hence, it is desirable to utilize electrodes that have the capabilities to create these oxidants and not dissipate for up to 5 years. As used herein, electrodes (particularly the anode) which are capable of being operated continuously at high voltages for extended periods of time are referred to as non-sacrificial anodes. For example, non-sacrificial anodes may be capable of operating at 480 volts DC and greater with current of up to 10 amps per square inch of anode. Various non-sacrificial electrodes and methods for producing non-sacrificial electrodes are disclosed in U.S. Pat. No. 3,443,055 to Gwynn et al., U.S. Pat. No. 3,479,275 to Gwynn et al., U.S. Pat. No. 3.547,600 to Gwynn et al., U.S. Pat. No. 3,616,355 to Themy et al., U.S. Pat. No. 4,201,651 to Themy, U.S. Pat. No. 4,316,787 to Themy, and U.S. Pat. No. 4,236,992 (hereinafter, 992) to Themy. But these examples did not run a single pass commercial format. These previous patents were for stand-still usage in still water or running only 18 volts.

### SUMMARY

The present disclosure pertains to water purification systems and particularly to a direct contact cell for the purification of water and sterilization of organics and inorganics used in water purification systems, such as waste water reuse. Specifically, this disclosure relates to the treatment of flow back and produced waters in the oil and gas industry and also the mining industry, for the destruction of pathogens, heavy metals, suspended solids, iron, cyanide fats and organic. More particularly, this disclosure pertains to a direct contact electrolytic cell which allows a single passage through the cell to handle flow rates of up to 42 gallons per minute, with efficient and effective results. The direct contact cell possesses an effective and efficient design that allows sterilization and disinfection of waste waters for reuse or for initial use. The direct contact cell is designed so water must pass the anode and cathode and utilizes a most efficient flow pattern between anode and cathode with a quarter inch gap by 7 inch width. Thus, high voltage electro oxidation is made efficient and viable as a single pass through the direct contact cell.

Waste water is run through the direct contact cell and oxidants, including hydroxyl radicals, ozone, chlorine, hydrogen peroxide and hypochlorus acid, are made in the direct contact cell. The cell is designed such that all water must flow by the cell, and it is efficient as the anodes produce oxidants across and on the side of the cathode. The ability to continuously produce these oxidant species is of considerable benefit in the art to take advantage of their oxidizing power. No other electrolytic cell design works like the direct contact cell. A synergism of high current electrolysis with a direct contact single pass cell design makes this cell superior in the field of electro oxidation.

In one implementation, the direct contact electrolysis cell provides a plurality of separate anodes disposed with the cell. The exterior of the cell provides cathodes in front of and behind the anodes. The anodes may provide a noble metal substrate with both sides of the anode fused to multiple layers of additional noble metals. The anode and cathode cell design allows for direct contact of water to both anode and cathode. Water must pass by each electrolytic cell and can do so at a rate of 40 to 500 gallons per minute with extreme efficiency. As all water passes through the cell, the electrolytic process occurs and the oxidants as described above are produced. Thus all water is oxidized, not just a portion. This enables a completely more effective treatment using the oxidants in conjunction with the water. Conductivity is tremendously improved over typical cell structures where water does not pass completely the anode and cathode. The addition of pure oxygen and outside air enhances the process as well.

The direct contact cell is revolutionary in its efficiency and performance. It is the first system to add pure oxygen and pure air to the high voltage electrolytic process, combined with the unique precious metal anode and direct contact design of the cell. Due to its design, the treatment of flow back and other waters produced in the oil and gas industry, as well as mining, rendering, dairy, textile, pulp and paper water treatment arenas, is possible. Other applications include destroying fats, organics and inorganics, as well as reducing turbidity, TSS, iron, heavy metals, bacteria, total petroleum hydrocarbons, barium, strontium, cyanide, peclorate and other organics and inorganics.

The foregoing has outlined rather broadly various features of the present disclosure in order that the detailed description that follows may be better understood. Additional features and advantages of the disclosure will be described hereinafter.

### BRIEF DESCRIPTION OF DRAWINGS

FIG. 1 shows a front view of a preferred embodiment of the direct contact cell described herein:

FIG. 2 shows a side view of a preferred embodiment of the direct contact cell described herein;

FIG. 3 shows a front perspective view of a preferred embodiment of the direct contact cell described herein; and

FIG. 4 shows a front view of an alternate preferred embodiment of the direct contact cell described herein.

### DETAILED DESCRIPTION OF PREFERRED EMBODIMENTS

The figures show preferred embodiments of the direct contact cell described in this disclosure. Depicted elements are not necessarily shown to scale and like or similar elements are designated by the same reference numeral through the several views. Referring to the drawings in general, it is understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this disclosure, the use of the singular includes the plural, the word “a” or “an” means “at least one”, and the use of “or” means “and/or”, unless specifically stated otherwise. Furthermore, the use of the term “including”, as well as other forms, such as “includes” and “included,” is not limiting. Also, terms such as “element” or “component” encompass both elements or components comprising one unit and elements or components that comprise more than one unit unless specifically stated otherwise.

As used herein, the term “brine” refers to, for example, an aqueous salt solution. For example, brine may refer to an aqueous sodium chloride solution, but other aqueous salt solutions are encompassed in other embodiments. In some cases, brine may be considered to have a salt concentration of about or greater 3,000 ppm. However, as discussed herein, brine will be considered to be any salt solution having a salt concentration greater than about 100 ppm up to 200,000 ppm.

As used herein, the term “wastewater” refers to, for example, a water source of any type polluted by at least one contaminant. Such contaminants may include, for example, organic compounds, inorganic compounds, heavy metals, biologics and combinations thereof.

As used herein, the term “purified water” refers to wastewater that has been treated by at least a portion of a water purification system or method. For example, purified water may be utilized to describe water that has passed through a flow electrolysis cells or water that has passed through an entire water purification system.

Water purification systems and methods described herein may generally provide flow electrolysis cells. The flow electrolysis cells may include at least one non-sacrificial anode, a cathode, an inlet port, and an outlet port. The non-sacrificial anode produces an electrooxidation cocktail including at least ozone, hypochlorite, hydroxyl radicals and hydrogen peroxide upon electrolysis of an aqueous brine solution. The electrooxidation cocktail may react with contaminants in wastewater, thereby assisting in the removal of contaminants as discussed herein. Various non-sacrificial electrodes and methods for producing non-sacrificial electrodes are described in International Application WO 2011/053916 to Themy et al, filed Nov. 1, 2010, which provides non-sacrificial anodes in the electrolysis cells.

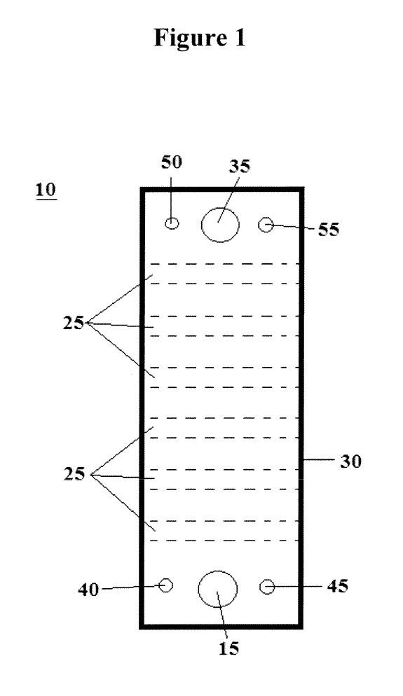

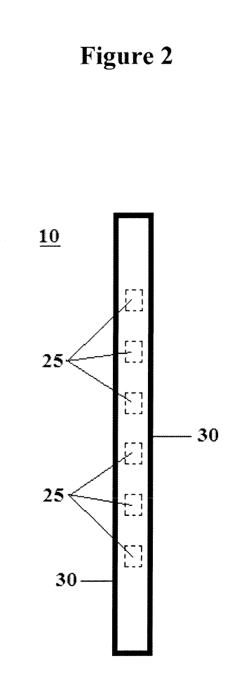

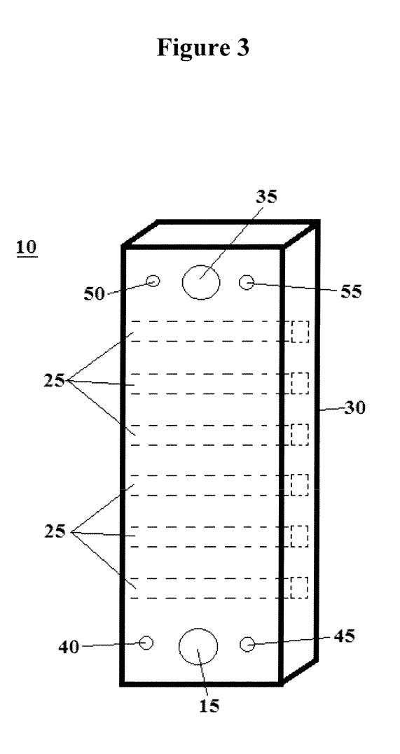

FIGS. 1-3 are illustrative implementations of a preferred embodiment of a direct contact cell 10. A direct contact electrolysis cell described herein provides for improved performance and efficiency. A wastewater stream is pumped into flow electrolysis cell 10 through inlet port 15. The design of direct contact cell 10 requires all wastewater flow pass a plurality of anodes 25 and one or more cathodes 30 resulting in nearly 100% electrolysis of the liquid in a single pass. The wastewater passes through a gap between an anode 25 and a cathode 30 that may be about ¼ inches wide. By using multiple separated anodes 25, the direct contact cell 10 maximizes efficiency by using electric current efficiency. High-voltage electrolysis (i.e., >12 V) may be conducted to perform electrooxidation. In some implementations, voltage may be as high as 50 V, or about 48V with 4 amps/in² on each anode. At higher current levels in direct contact cell 10, less salinity is needed to produce the desired oxidants. As a result, in contrast to other electrolytic cells, direct contact cell 10 does not require a significant addition of salt to the wastewater.

As the wastewater stream is flowed through direct contact cell 10 from inlet port 15 to outlet port 35, non-sacrificial anodes 25 and cathodes 30 may be connected to a high voltage power supply, thereby exposing the wastewater to high voltages. Exposure of the wastewater to the high voltages results in formation of at least ozone, hydroxyl radicals, monatomic chlorine and hydrogen peroxide. All of these components are powerful oxidizing agents that efficiently oxidize and substantially remove any biological oxygen demand (BOD), chemical oxygen demand (COD), total organic carbon (TOC), total petroleum hydrocarbons, cations, iron related bacteria, sulfate reducing bacteria, slime, heavy metals and other organic/inorganic pollutants and bacteria present in the wastewater. The higher the current, the more oxidizing agents produced, including at least ozone, hydroxyl radicals, monatomic chlorine and hydrogen peroxide. Contaminants such as, for example, ammonium sulfides, hydrocarbons, iron, manganese and other heavy metals, are readily oxidized and removed from the wastewater stream.

Flow electrolysis direct contact cell 10 operates at a relatively high current that allows the wastewater stream to be treated in a single pass through the cell. The contaminants may be removed as a microflocculant after electrooxidation. For example, oils and organics may separate from the wastewater upon oxidation and inorganics may precipitate as a microflocculant. Oxidized organic compounds may also precipitate as a microflocculant in some embodiments. For example, metals are electrochemically oxidized into a metal oxide and then released as a microflocculant sediment. The process safely and efficiently converts the supplied wastewater into an output stream flowing from outlet port 35 of direct contact cell 10 having levels of chlorine and mixed oxidants lower than a maximum amounts allowed by environmental regulations.

In the past some electrolysis cells have utilized an anode that spans nearly the entire height of the cell. It was previously believed that the anode should span the entire height of the cell for efficient electro-oxidation. In contrast, direct contact cell 10 provides multiple anodes 25 separated by a predetermined distance. However, direct contact cell 10 has demonstrated an increase of approximately 50% in efficiency over an equivalent cell with an anode spanning the entire height. Wastewater passing by a separation area between the anodes 25 and cathodes 30 is still electrolyzed and, by design, water must pass between anodes 25 and cathodes 30 in the direct contact cell 10. Cathodes 30 are provided in front of and behind anodes 25. The entire cell 10 may be surrounded by an exterior housing, which is not shown. In some implementations, anodes 25 may be rectangular bar shaped members. For example, anodes 25 may be 2 inches thick, 6 inches tall, and 6 inches wide. In some implementations, anodes 25 may comprise a combination of noble metals. For example, anodes 25 may provide a titanium substrate with layers of platinum, tantalum, and niobium foils fused to the substrate. Cathodes 30 may be a plate spanning the height of direct contact cell 10. Cathode 30 may be any suitable conductive noble metal. For example, cathode 30 may be 316L stainless steel or high grade titanium. Anodes 25 are separated by a predetermined distance. For example, anodes 25 may be separated by 3-4 inches in a non-limiting example. Further, multiple anodes 25 may be provided in a direct contact cell 10. While six anodes 25 are shown in the figures, any number of anodes may be utilized in a direct contact cell.

Direct contact cell 10 may also provide a gas injection port 40. In some implementations, gas injection port 40 may be utilized to inject air or pure oxygen during electro-oxidation. For example, a gas may be injected through gas injection port 40 using a compressor, a pressurized tank, or the like. Gas injection causes agitation and provides more contact time between the water and anodes 25. Gas injection increases mixed oxidants and ozone production, and the agitation aids in separating precipitates from the water. As a result, air injection provides direct air flotation which helps in separating cations, petroleum hydrocarbons, COD, TOC, BOD, and the like out of the water. In some implementations, pure oxygen may be injected into the water instead of air or in conjunction with air. Efficiency of direct contact cell 10 may further increased by 30% with oxygen injection and 50% with oxygen and air injection.

Direct contact cell 10 may also provide a secondary injection port 45 for injection of additional chemicals to aid the electro-oxidation process. Further, secondary injection port 45 may be utilized to clean cell 10 by injecting an acid wash or the like. Additional optional secondary outlet ports 50 and 55 can also be present in the direct contact cell 10.

Direct contact cell 10 may capable of processing more than 40 gallons per minute. Direct contact cell 10 may also be capable of processing at pressures up to 40 psi. Multiple direct contact cells 10 may be combined to provide electro-oxidation processing through the cells in parallel or series.

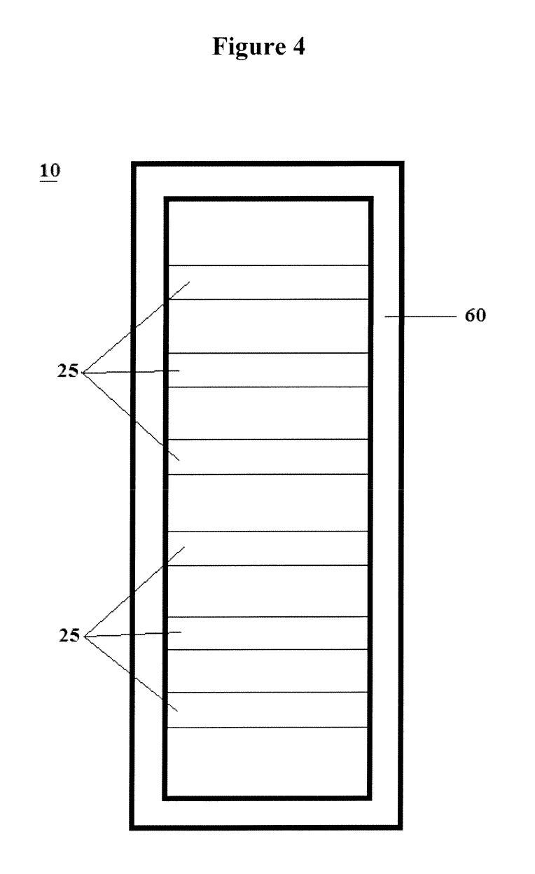

In a further embodiment of the direct contact cell shown in FIG. 4, anodes 25 may be mounted on a non-conductive rack 60 that secures the anodes 25. This non-conductive rack 60 with mounted anodes 25 can then be placed in appropriate proximity to one or more cathodes and arranged to have the desired inlet and outlet ports.

Implementations described herein are included to demonstrate particular aspects of the present disclosure. It should be appreciated by those of skill in the art that the implementations described herein merely represent exemplary implementation of the disclosure. Those of ordinary skill in the art should, in light of the present disclosure, appreciate that many changes can be made in the specific implementations described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The implementations described hereinabove are meant to be illustrative only and should not be taken as limiting of the scope of the disclosure.

What is claimed is:

1. A direct contact cell for water purification, comprising:
an inlet port for injection of waste water;
a plurality of anodes, wherein the plurality of anodes are separated from each other by a predetermined distance;
one or more cathodes, wherein the plurality of anodes and the one or more cathodes are positioned such that all waste water must pass through a gap between at least one anode and at least one adjacent cathode, and wherein the plurality of anodes and the one or more cathodes produce a voltage between them that electrolyzes the waste water; and
an outlet port for collection of purified water.

2. The direct contact cell of claim 1, wherein the anodes and the cathodes are non-sacrificial.

3. The direct contact cell of claim 1, wherein the anodes comprise a combination of noble metals.

4. The direct contact cell of claim 1, wherein the anodes comprise a titanium substrate having an upper surface and having layers of platinum, tantalum, and niobium foils fused to the upper surface.

5. The direct contact cell of claim 1. wherein the anodes comprise rectangular bar shaped members

6. The direct contact cell of claim 1, wherein the cathodes comprise a noble metal.

7. The direct contact cell of claim 1, wherein the cathodes comprise stainless steel or titanium.

8. The direct contact cell of claim 1, wherein the cathodes comprise plates having a length approximately equal to a length of the direct contact cell.

9. The direct contact cell of claim 1, wherein the predetermined distance separating the plurality of anodes is about 3 to about 4 inches.

10. The direct contact cell of claim 1, wherein the gap between at least one anode and at least one adjacent cathode is about ¼ inches.

11. The direct contact cell of claim 1, further comprising a gas injection port for the injection of air or oxygen.

12. The direct contact cell of claim 1, further comprising one or more secondary injection ports for the injection of chemicals or gases.

13. The direct contact cell of claim 1, further comprising one or more secondary outlet ports.

14. The direct contact cell of claim 1, further comprising a non-conductive rack on which the plurality of anodes are mounted.

15. The direct contact cell of claim 1, wherein the voltage is greater than about 12 volts.

16. The direct contact cell of claim 1, wherein the voltage is greater than about 12 volts and less than about 50 volts.

17. The direct contact cell of claim 1, wherein the direct contact cell accepts flow rates of up to 42 gallons of waste water per minute.

18. A water purification system, comprising a plurality of the direct contact cells of claim 1, wherein the plurality of direct contact cells are connected in parallel or in series.

19. A water purification system, comprising:
a plurality of direct contact cells, wherein each direct contact cell comprises:
an inlet port for injection of waste water;
a plurality of anodes, wherein the plurality of anodes are separated from each other by a predetermined distance;
one or more cathodes, wherein the plurality of anodes and the one or more cathodes are positioned such that all waste water must pass through a gap between at least one anode and at least one adjacent cathode, and wherein the plurality of anodes and the one or more cathodes produce a voltage between them that electrolyzes the waste water; and
an outlet port for collection of purified water,
wherein the plurality of direct contact cells are connected in parallel or in series.

20. The water purification system of claim 19, wherein the anodes comprise a titanium substrate having an upper surface and having layers of platinum, tantalum, and niobium foils fused to the upper surface.

21. The water purification system of claim 19, wherein the cathodes comprise stainless steel or titanium.

22. The water purification system of claim 19, wherein the predetermined distance separating the plurality of anodes is about 3 to about 4 inches.

23. The water purification system of claim 19, wherein the gap between at least one anode and at least one adjacent cathode is about ¼ inches.

24. A method for the purification of waste water, comprising:
passing the waste water through a direct contact cell at a predetermined flow rate, wherein the direct contact cell comprises:
an inlet port for injection of the waste water,
a plurality of anodes, wherein the plurality of anodes are separated from each other by a predetermined distance,
one or more cathodes, and
an outlet port,
wherein all of the waste water passes through a gap between at least one anode and at least one adjacent cathode within the direct contact cell;
electrolyzing the waste water by a voltage passing between the plurality of anodes and the one or more cathodes; and
collecting purified water from the outlet port.

25. The method of claim 24, wherein the anodes and the cathodes are non-sacrificial.

26. The method of claim 24, wherein the anodes comprise a combination of noble metals.

27. The method of claim 24, wherein the anodes comprise a titanium substrate having an upper surface and having layers of platinum, tantalum, and niobium foils fused to the upper surface.

28. The method of claim 24, wherein the anodes comprise rectangular bar shaped members

29. The method of claim 24, wherein the cathodes comprise a noble metal.

30. The method of claim 24, wherein the cathodes comprise stainless steel or titanium.

31. The method of claim 24, wherein the cathodes comprise plates having a length approximately equal to a length of the direct contact cell.

32. The method of claim 24, wherein the predetermined distance separating the plurality of anodes is about 3 to about 4 inches.

33. The method of claim 24, wherein the gap between at least one anode and at least one adjacent cathode is about ¼ inches.

34. The method of claim 24, wherein the direct contact cell further comprises a gas injection port.

35. The method of claim 34, further comprising the step of injecting oxygen or air into the waste water through the gas injection port while passing the waste water through the direct contact cell.

36. The method of claim 24, wherein the direct contact cell further comprises one or more secondary injection ports.

37. The method of claim 36, further comprising the step of injecting chemicals or gases into the waste water through the secondary injection ports while passing the waste water through the direct contact cell.

38. The method of claim 24, wherein the direct contact cell further comprises one or more secondary outlet ports.

39. The method of claim 24, wherein the direct contact cell further comprises a non-conductive rack on which the plurality of anodes are mounted.

40. The method of claim 24, wherein the waste water is electrolyzed by a voltage greater than about 12 volts.

41. The method of claim 24, wherein the waste water is electrolyzed by a voltage greater than about 12 volts and less than about 50 volts.

42. The method of claim 24, wherein the predetermined flow rate of the waste water is up to 42 gallons of waste water per minute.

43. The method of claim 24, further comprising the step of passing the purified water through one or more additional direct contact cells, wherein the direct contact cells are connected in parallel or in series.
